(19) United States
(12) Patent Application Publication
(10) Pub. No.: US 2011/0161507 A1
(43) Pub. Date: Jun. 30, 2011

(54) METHOD AND SYSTEM FOR TIME-LIMITATION SETTINGS IN COMMUNICATION SESSIONS

(76) Inventors: PATRICK JOSEPH O'SULLIVAN, Ballsbridge (IE); Liam Harpur, Skerries (IE); Barry E. Willner, Briarcliff Manor, NY (US)

(21) Appl. No.: 12/650,674

(22) Filed: Dec. 31, 2009

(51) Int. Cl. G06F 15/16

(52) U.S. Cl. 709/228

(57) ABSTRACT

A method and computer program product includes initiating an instant messaging session on one or more communication devices. A first time-limitation setting for the instant messaging session based upon a user identification may be received. The first time-limitation setting may represent a maximum duration for the instant messaging session. A second time-limitation setting for the instant messaging session based upon the user identification may also be received. The second time-limitation setting may represent a minimum time between one or more instant messaging sessions. The instant messaging session may be terminated if the duration of the instant messaging session exceeds the first time-limitation setting. A subsequent instant messaging session may be prevented if the time between the instant messaging session and the subsequent communication does not exceed the second time-limitation setting.

### BACKGROUND

This disclosure relates to electronic communication and, more particularly, to time-limitation settings in communication sessions.

More and more people communicate with each other through digital communication sessions. These communication sessions include instant messaging sessions, digital telephony sessions, video chat sessions, and other forms of interactive communication. Often, a user will communicate with multiple people at the same time by engaging in multiple instant messaging sessions, multiple chat sessions, etc. If a user becomes bogged down with multiple communication sessions, the communication sessions can be time consuming and may lead to inefficiencies, especially in the workplace.

Typically, if two participants in a communication session find themselves under a time restraint, they may conduct their business more efficiently. However, a user may wish to modify the time constraints depending upon who the user is communicating with. For example, the user may wish to selectively create time constraints or time limitations depending on the identity of the other user, the group the other user works for, etc.

### BRIEF SUMMARY

In an embodiment, a method includes initiating an instant messaging session on one or more communication devices. A first time-limitation setting for the instant messaging session based upon a user identification and representing a maximum duration for the instant messaging session may be received. A second time-limitation setting for the instant messaging session based upon the user identification and representing a minimum time between one or more instant messaging sessions may also be received. If the duration of the instant messaging session exceeds the first time-limitation setting, the instant messaging session may be terminated. If the time between the instant messaging session and a subsequent instant messaging session does not exceed the second time-limitation setting, initiation of the subsequent instant messaging session may be prevented.

One or more of the following features may be included. The instant messaging session and/or the subsequent instant messaging session may be instant messaging sessions. The first time-limitation setting and the second time-limitation setting may be based upon a user identification for a class of users. The first time-limitation setting and the second time-limitation setting may also be based upon an organizational position of a user associated with the user identification.

The first time-limitation setting and the second time-limitation setting may be based upon a weighting of the user identification, the weighting corresponding to a type of user associated with the user identification. The first time-limitation setting and the second time-limitation setting may be based upon a distance between two or more instant messaging session participants in a social networking graph. The first time-limitation setting and the second time-limitation setting may also be based upon a policy of a business organization.

The first time-limitation setting and the second time-limitation setting may be displayed on a computer display. The first time-limitation setting and the second time-limitation setting may be overridden based upon the user identification and one or more time-limitation settings set by the user associated with the user identification.

In another embodiment, a computer program product resides on a computer readable storage device, having a plurality of instructions stored thereon, which, when executed by a processor, cause the processor to perform operations including initiating an instant messaging session on one or more communication devices. A first time-limitation setting for the instant messaging session based upon a user identification and representing a maximum duration for the instant messaging session may be received. A second time-limitation setting for the instant messaging session based upon the user identification and representing a minimum time between one or more instant messaging sessions may also be received. If the duration of the instant messaging session exceeds the first time-limitation setting, the instant messaging session may be terminated. If the time between the instant messaging session and a subsequent instant messaging session does not exceed the second time-limitation setting, initiation of the subsequent instant messaging session may be prevented.

One or more of the following features may be included. The instant messaging session and/or the subsequent instant messaging session may be instant messaging sessions. The first time-limitation setting and the second time-limitation setting may be based upon a user identification for a class of users. The first time-limitation setting and the second time-limitation setting may also be based upon an organizational position of a user associated with the user identification.

The first time-limitation setting and the second time-limitation setting may be based upon a weighting of the user identification, the weighting corresponding to a type of user associated with the user identification. The first time-limitation setting and the second time-limitation setting may be based upon a distance between two or more instant messaging session participants in a social networking graph. The first time-limitation setting and the second time-limitation setting may also be based upon a policy of a business organization.

The first time-limitation setting and the second time-limitation setting may be displayed on a computer display. The first time-limitation setting and the second time-limitation setting may be overridden based upon the user identification and one or more time-limitation settings set by the user associated with the user identification.

### BRIEF DESCRIPTION OF SEVERAL VIEWS OF THE DRAWINGS

FIG. 1 is a diagrammatic view of an example of a system architecture within which a communication process may reside.

FIG. 2 is an example of a block diagram of a computing device.

FIG. 3 is an example of a flowchart diagram of a communication process.

FIG. 4 is an example of a graphical user interface panel for a communication application.

FIG. 5 is an example of a graphical user interface.

In the figures, like reference designators may denote like elements.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer-readable (i.e., computer-usable) medium(s) having computer-usable program code embodied thereon.

Any combination of one or more computer-readable medium(s) may be utilized. The computer-readable medium may be a computer readable signal medium or a computer readable storage medium. A computer-readable storage medium may be, for example, but not limited to, an electronic, magnetic, optical, electromagnetic, infrared, or semiconductor system, apparatus, a device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Note that the computer-readable storage medium could even be paper or another suitable medium upon which a program is printed, as the program can be electronically captured, via, for instance, optical scanning of the paper or other medium, then compiled, interpreted, or otherwise processed in a suitable manner, if necessary, and then stored in a computer memory. In the context of this document, a computer-readable storage medium may be any medium that can contain, or store a program for use by or in connection with an instruction execution system, apparatus, or device.

A computer readable signal medium may include a propagated data signal with computer-usable program code embodied therein, for example, in baseband or as part of a carrier wave. Such a propagated signal may take any of a variety of forms, including, but not limited to, electro-magnetic, optical, or any suitable combination thereof, a computer readable signal medium may be any computer-readable medium that can contain, store, communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc.

Computer program code for carrying out operations of the present invention may be written in an object oriented programming language such as the Java® language, Smalltalk, C++ or the like. (Java and all Java-based trademarks and logos are trademarks of Sun Microsystems, Inc. in the United States, other countries, or both). However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory and/or computer readable storage medium that can direct a computer or other programmable data processing apparatus to function in a particular manner, such that the instructions stored in the computer-readable memory and/or computer readable storage medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

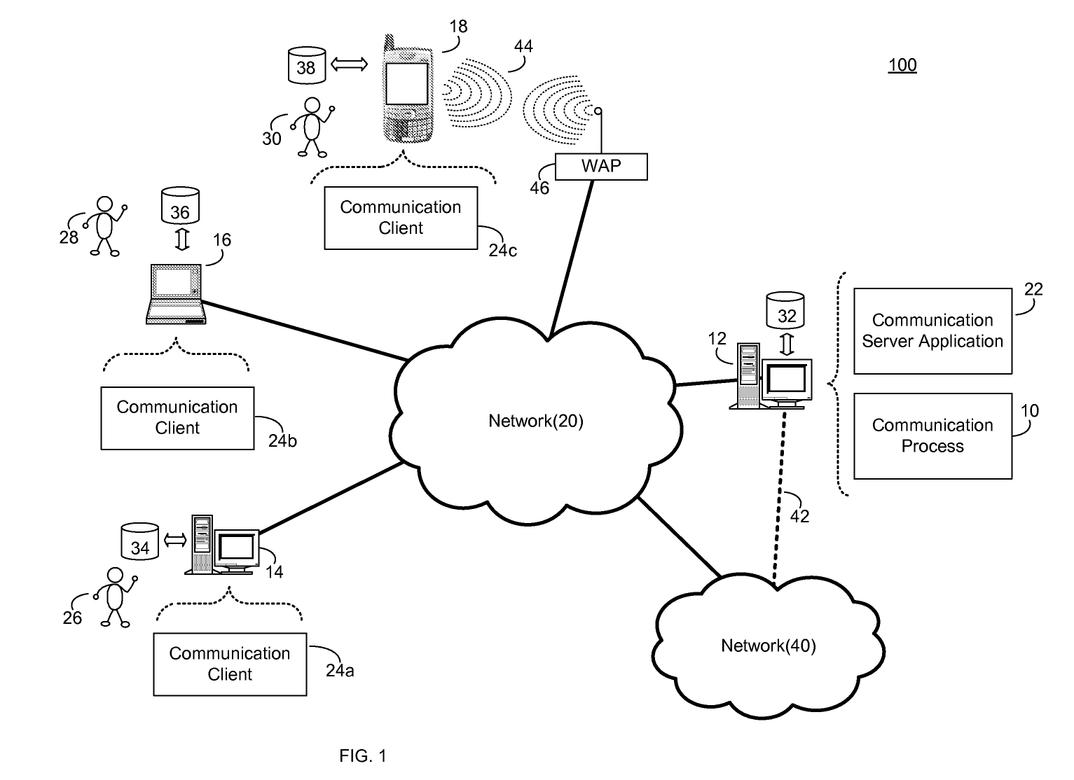

FIG. 1 depicts computing infrastructure 100 within which communication process 10 may reside. As shown, communication process 10 may reside on and may be executed by computer 12. Although not shown, communication process 10 may also reside on and may be executed by computer 14, laptop 16, personal digital assistant (“PDA”) 18, or any other computing device capable of executing communication process 10. The various computing devices, including computers 12, 14, laptop 16, and/or PDA 18, may each be directly or indirectly connected to network 20 (e.g., the Internet or a local area network).

Computer 12 may be a server device. Computer 14, laptop 16, and PDA 18 may be end user devices. Computers 12, 14, laptop 16, and PDA 18 may run network operating systems, examples of which may include but are not limited to: Microsoft Windows XP® Server; Novell® Netware®; or Redhat® Linux®, for example (Windows XP is a registered trademark of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

Computer 12 may be a server computer, such as a web server, blog server, email server, instant messaging server, telephony server, video conference server, or other server that provides communication services to end users, for example. Computer 12 may execute various server applications, which may include a web server, a file server, a file transfer protocol server, or any other kind of server application. Examples of computer 12 may include, but are not limited to: a personal computer, a server computer, a series of server or personal computers, a mini computer, and a mainframe computer, for example.

Computer 12 may execute communication server application 22, which may be an application configured to provide communication services to users 26, 28, 30, for example. Communication server application 22 may be a telephony server application that provides audio communication services, a video conferencing application that provides video conferencing services, an instant messaging application, an email application, a chat application, an IRC application, or any other application that provides communication services between users, such as users 26, 28, 30.

FIG. 1 also depicts communication clients 24a, 24b, 24c, which may reside on and may be executed by any appropriate computing device, including, but not limited to, computers 12, 14, laptop 16, and/or PDA 18. Communication clients 24a, 24b, 24c may be any type of communication client software applications. For example, communication clients 24a, 24b, 24c may be video conferencing applications, telephony/VoIP applications, email applications, instant messaging applications, and the like. Continuing the example, communication clients 24a, 24b, 24c may allow users 26, 28, 30 to communicate with each other via communication server application 22. For example, user 26 may use communication client 24a to begin a voice conference session. Communication client 24a may communicate with communication server application 22, which may provide voice conferencing services. Communication server application 22 may initiate a voice conference and allow user 26, user 28, and user 30 to use communication client 24a, communication client 24b, and communication client 24c, respectively, to connect to communication server application 22. Once connected, users 26, 28, 30 may communicate with each other via the voice conferencing session between communication server 22 and/or communication clients 24a, 24b, 24c.

As will be discussed below in greater detail, communication process 10 may initiate 302 a communication session, i.e. an instant messaging session, on one or more communication devices, such as computers 12, 14, laptop 16, and/or PDA 18. Communication process 10 may receive a first time-limitation setting for the communication session based upon a user identification. The first time-limitation setting may represent a maximum duration for the instant messaging session. Communication process 10 may also receive a second time-limitation setting for the instant messaging session based upon the user identification. The second time-limitation setting may represent a minimum time between one or more instant messaging sessions. Communication process 10 may terminate the instant messaging session if the duration of the instant messaging session exceeds the first time-limitation setting. Communication process 10 may also prevent initiation of a subsequent instant messaging session if the time between the instant messaging session and the subsequent instant messaging session does not exceed the second time-limitation setting.

The instruction sets and subroutines of communication process 10, which may include one or more software modules and one or more sets of software instructions, may be stored on storage device 32 coupled to computer 12. The instruction sets and subroutines of communication clients 24a, 24b, 24c may be stored on storage device 34 coupled to computer 14, storage device 36 coupled to laptop 16, and storage device 38 coupled to PDA 18, respectively. Communication process 10 may be executed by one or more processors and one or more memory architectures incorporated into the various electronic devices. Examples of storage devices 32, 34, 36, 38 may include but are not limited to: hard disk drives; solid state drives; tape drives; optical drives; RAID arrays; random access memory (RAM); read-only memory (ROM); and the like.

The instruction sets and subroutines of communication process 10 may be generated through the use of a compiler, such as the IBM XL compiler, the Visual Studio® compiler, or an assembler, for example (Visual Studio is a registered trademark of Microsoft Corporation in the United States, other countries, or both). The instruction set and subroutines may also be generated as scripts, such as JavaScript® scripts, or as other types of software code (Java and all Java-based trademarks and logos are trademarks of Sun Microsystems, Inc. in the United States, other countries, or both). In general, and as is known in the art, the instruction sets and subroutines of communication process 10 may be generated via any method of generating instruction sets and subroutines that may be executed by a processor.

As mentioned, various client electronic devices may be coupled to network 20. Examples of client electronic devices may include, but are not limited to: computer 12, computer 14, laptop 16, PDA 18, a game console (not shown), cellular telephone (not shown), and a dedicated network device (not shown). One or more users (e.g., users 26, 28, 30) may access the various tools and applications, such as communication process 10, communication server application 22, and/or communication client 24a, 24b, 24c, from any device connected to network 20 or directly from the device on which the tool or application resides.

Various computer devices and/or client electronic devices may be coupled directly to network 20, or may be indirectly coupled to network 20 through network 40. For example, computer 12 is shown directly connected to network 20. However, computer 12 may also be indirectly connected to network 20 through secondary network 40, as illustrated by phantom link line 42.

The various client electronic devices may be directly, indirectly, and/or wirelessly coupled to network 20 (or network 40). For example, computers 12, 14, and laptop 16 are shown directly coupled to network 20 via hardwired network connections. PDA 18 is shown wirelessly coupled to network 20 via wireless communication channel 44 established between PDA 18 and wireless access point (i.e., WAP) 46, which is shown directly coupled to network 20. WAP 48 may be, for example, an IEEE 802.11a, 802.11b, 802.11g, Wi-Fi, cellular, and/or Bluetooth device that is capable of establishing wireless communication channel 46 between PDA 18 and WAP 46.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

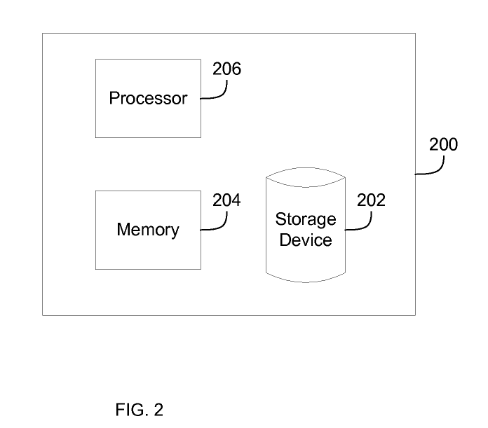

FIG. 2 shows a block diagram of computing device 200. Computing device 200 may be any computing device capable of executing communication process 10, communication server application 22 and/or communication clients 24a, 24b, 24c. Computing device 200 may include storage device 202. Storage device 202 may be a hard drive, DVD drive, CD drive, Flash memory, RAID array, or any other computer readable storage device. Computing device 200 may also include memory 204. Memory 204 may be a single memory or a series of memories. Memory 204 may be a memory device including, but not limited to, a read only memory (ROM), a random access memory (RAM), a flash memory, an EEPROM, or any other type of computer readable memory. The instruction sets and subroutines of communication process 10, communication server application 22, and/or communication clients 24a, 24b, 24c may be stored in memory 204 and/or storage device 202, for example.

Computing device 200 may also include processor 206. Processor 206 may be a single processor or a series of processors. Processor 206 may be a general purpose processor, or a specialized processor. In general, processor 206 may be any processor capable of executing software and/or software instructions. Processor 206 may be coupled to memory 204 and/or storage device 202 and may read and execute software instructions and routines stored on memory 204 and/or storage device 202. When processor 206 executes the instruction sets and subroutines of communication process 10, communication server application 22 and/or communication clients 24a, 24b, 24c, the instructions and subroutines may cause processor 206 to perform various operations, which will be discussed below in greater detail.

One skilled in the art will recognize that computing device 200 may also include various other parts and devices that may facilitate computing operations. For example, computing device 200 may include a north bridge chip, a south bridge chip, a memory bus, an IDE or SATA bus, and various input and output buses and devices, such as a USB bus, a network interface, a mouse, a keyboard, and/or a monitor. In general, computing device 200 may be any computing device, with any computing architecture, capable of executing communication process 10, communication server application 22 and/or communication clients 24a, 24b, 24c.

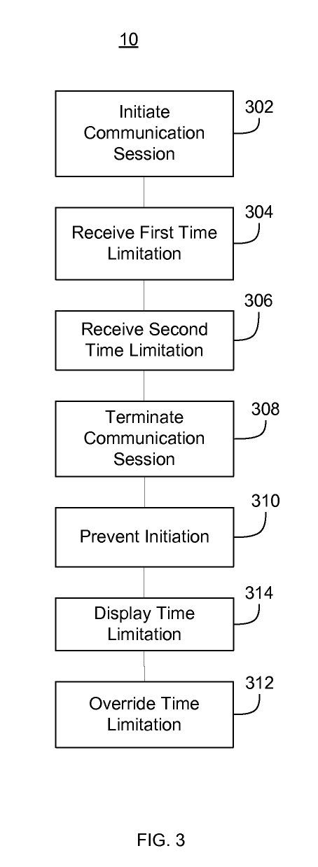

FIG. 3 depicts a flowchart that may include various operations associated with communication process 10. As shown, communication process 10 may initiate 302 a communication session, e.g. an instant messaging session, on one or more communication devices, such as computers 12, 14, laptop 16, and/or PDA 18. Communication process 10 may receive 304 a first time-limitation setting for the communication session based upon a user identification. The first time-limitation setting may represent a maximum duration for the communication session. Communication process 10 may also receive 306 a second time-limitation setting for the communication session based upon the user identification. The second time-limitation setting may represent a minimum time between one or more communication sessions. Communication process 10 may terminate 308 the communication session if the duration of the communication session exceeds the first time-limitation setting. Communication process 10 may also prevent 310 initiation of a subsequent communication session if the time between the communication session and the subsequent communication does not exceed the second time-limitation setting.

Communication process 10 may initiate 302 a communication session. For example, assume user 30 wishes to communicate with user 26. User 30 may open a communication session, such as an instant messaging session, via communication client 24c. Communication client 24c may request that server 12 and/or communication server application 22 initiate 302 a communication session between user 30 (using communication client 24c) and user 26 (using communication client 24a). Communication server application 22 may then initiate 302 the communication session between user 30 and user 26 by providing communication services and/or a communication pipe through which user 30 and user 26 may communicate. The communication services may include instant messaging services, video chat services, audio/telephony services, email services, or any other form of communication services.

Communication process 10 may also receive 304 a first time-limitation setting for the communication session based upon a user identification. Continuing the example, user 30 may be a busy person and may not want to conduct the communication session with user 26 efficiently. User 30 may wish to set a time limit that limits the duration of time user 26 may communicate with user 30 via the communication session. For example, user 30 may wish to limit the duration of the communication session to five minutes. In this example, communication process 10 may receive 304 a first time-limitation setting of five minutes. The first time-limitation setting may represent a maximum duration for the communication session. For example, if communication process 10 receives 302 a first time-limitation setting of five minutes, then communication process 10 may limit the duration of the communication session to five minutes. If the communication session exceeds five minutes, communication session 10 may terminate 308 the communication session.

The time-limitation setting may be based upon a user identification. For example, user 30 may wish to limit communication sessions with user 26 to five minutes. In this example, communication process 10 may receive 304 the first time-limitation setting, which may limit user 26's communication to five minutes. Additionally/alternatively, user 30 may wish to limit communication session with user 28 to ten minutes. In this example, communication process 10 may receive 304 a time-limitation setting, which may limit user 26's communication to five minutes, and another time-limitation setting, which may limit user 28's communication to ten minutes. The time-limitation setting may limit the time of a communication session based on the user identification, which may include a user's login name, address, group membership, organizational position, and the like. In the examples above, the identification may represent an individual user. However, this is not meant to be a limitation. The user identification may also represent a type of user, a group of users, a class of users, or any other individual user or group of users.

If the duration of the communication session exceeds the first time-limitation setting, communication process 10 may terminate 308 the communication session. Terminating 308 the communication session may include breaking the connection between users in the communication session and/or blocking further communications or messages between the users in the communication session. In general, communication process 10 may terminate 308 the communication session using any appropriate manner of preventing further communication between users.

Communication process 10 may also receive 306 a second time-limitation setting for the communication session based upon the user identification. The second time-limitation setting may represent a minimum time between one or more communication sessions. For example, user 30 may wish to limit communication sessions so that user 26 may only initiate a communication session with user 30 for five minutes each hour. In this case, user 30 may set, and communication process 10 may receive 304 a first time-limitation setting of five minutes, that limits the duration of a communication session. Additionally/alternatively, user 30 may set, and communication process 10 may receive 306 a second time-limitation setting of one hour, that limits the time between the communication session and a subsequent communication session to a minimum of one hour. For example, if communication process 10 receives 304 a first time-limitation setting of five minutes and receives 306 a second time-limitation setting of one hour, communication process 10 may terminate 308 the communication session after five minutes, and may prevent 310 initiation of another, subsequent communication session for one hour. The time between communication sessions may be measured from the beginning of the first communication session, from the end of the first communication session, from an arbitrary point in time set by a user, or from any appropriate point in time.

User 30 may use communication process 10 to limit or control the way another user communicates with user 30. For example, user 30 may set, and communication process 10 may receive 304, 306 the first and second time-limitation settings, which may limit the duration of a communication session and/or the time between communication sessions.

The first and/or second time-limitation settings may be based on a user identification. A user identification may identify a user, group, business organization, or any other type of individual user or group of users. For example, the first and/or second time-limitation setting may be based upon a user identification that identifies a specific user. In this case, the first and/or second time-limitation setting may limit the amount of time the individual user can participate in the communication session. If the individual user engages in a communication session, communication process 10 may limit the time of the user's communication session and may terminate 308 the user's communication session and/or prevent 310 initiation of a subsequent communication session by the user.

Additionally/alternatively, the first and/or second time-limitation settings may be based upon a user identification for a class of users. The class of users may be a social group, a business group, a contact list, or any other group of users. In this case, the first and/or second time-limitation setting may limit the time that any or all members of the group engage in the communication session. For example, user 30 may set a first and second time-limitation setting that applies to members of a class of users. If a member of the class of users engages in a communication session with user 30, communication process 10 may limit the time of the class member's communication session and may terminate 308 the class member's communication session and/or prevent 310 the class member from initiating a subsequent.

The first and/or second time-limitation settings may also be based upon a user identification for an organizational position. For example, a lightweight directory access protocol (LDAP) directory may identify various organizational positions. The user identification may be based upon organizational positions within an LDAP directory, an organizational chart, or other directory or data structure that identifies organizational positions.

An LDAP directory may include information about individuals in a business organization. For example, the LDAP may be an hierarchical directory that may include a user's name, address, location, organizational position, business unit, keywords associated with the participant, etc. The user identification may be based upon information from the LDAP directory. For example, user 30 may wish to set a short time limit for communication sessions between user 30 and user 30's employees, but may wish to set a long time limit for communication sessions between user 30 and user 30's managers. In this example, the user identification may identify user 30's employees and/or user 30's managers. Communication process 10 may receive 304, 306 a first and second time-limitation setting that sets a short time limit for user 30's employees, and may receive 304, 306 a first and second time-limitation setting that sets a long time limit for user 30's managers. Communication process 10 may determine which users are user 30's employees and managers by reading information from an LDAP directory.

The first and/or second time-limitation setting may be based upon a relative organizational position or an absolute organizational position. In the example above, the first and/or second time-limitation settings may be based upon a relative organizational position because the first and/or second time-limitation settings are based upon a user's position with respect to user 30, i.e. the time-limitation settings may be based upon a user's status as user 30's employee or user 30's manager. Additionally/alternatively, the first and/or second time-limitation setting may be based upon an absolute organizational position. For example, the first and/or second time-limitation settings may apply to all executives, all vice presidents, all program managers, all engineers, all social contacts, etc.

The first and/or second time-limitation setting may be based upon a weighting of the user identification. The weighting may correspond to a type of user associated with the user identification. Different types of users may be given different weightings. As an example, engineers may be given a weighting of five, executives may be given a weighting of ten, and social contacts may be given a weighting of fifteen, etc. The first and/or second time-limitation settings may be based on the weighting. For example, the time-limitation settings for users with a weighting of five or less may restrict the users to shorter and/or infrequent communication sessions; the time-limitation settings for users with a weighting between five and ten may be restricted to longer and/or more frequent communication sessions, etc.

The first and/or second time-limitation settings may be based upon a distance between two or more users in a social networking graph or. The first and/or second time-limitation settings may also be based upon a distance between two or more users in an organizational directory, such as an LDAP directory. A social networking graph may be a graph of users connected directory or indirectly through social relationships. An example of a social network is the Facebook® website. (Facebook is a registered trademark of Facebook, Inc. in the United States, other countries, or both). The Facebook site allows users to create connections with each other based on social relationship or “friend” status. As an example, social networking user A may be connected directly to social networking user B, who may in turn be connected to social networking user C. In this example, the distance between social networking user A and social networking user B may be one, because social networking user A and social networking user B are directly connected. The distance between social networking user A and social networking user C may be two because social networking user A and social networking user C are indirectly connected through social networking user B. A distance between users may also be seen in organizational directories, such as an LDAP directory. Assume that, in an organizational directory, employee A reports to manager B, who in turn reports to manager C. the distance between employee A and manager B may be one because employee A reports directly to manager B. The distance between employee A and manager C may be two because employee A reports to manager C indirectly through manager B.

The first and/or second time-limitation settings may be based upon a distance between two or more users in a social networking graph and/or organizational directory. For example, user 30 may create a setting that specifies time-limitation settings for users based on the users' distance from user 30 in a social networking graph or organizational directory. User 30 may, for example, specify that users who are separated from user 30 by a distance of one may initiate 302 communication sessions for longer durations and/or more frequently than users who are separated from user 30 by a distance of two. The example above is used as an illustration. One skilled in the art will recognize that time-limitation settings of any length or duration may be based upon any degree of distance between users and is not limited to distances of one or two.

The time-limitation setting may be a setting entered by a user and may represent an individual user's preferences, a group policy, a policy of a business organization, etc. For example, an individual user, i.e. user 30, may enter preferences for the first and second time-limitation settings. Additionally/alternatively, a group administrator or IT administrator may enter first and second time-limitation settings that apply to any or all members of a group. For example, an IT administrator may set first and second time-limitation settings for an engineering department, a legal department, a human resources department, a windows security group, etc.

If users participating in a communication session have conflicting time-limitation settings, communication session 10 may override one or more of the first time-limitation setting and the second time-limitation setting based on the user identification and one or more time-limitation settings set by a user associated with the user identification. For example, assume user 30 is the manager of user 26. User 26 may set a first and second time-limitation setting so that communication sessions last 30 minutes and can be initiated every hour. However, user 30 may set a first and second time-limitation setting so that communication sessions with user 26 last a maximum of five minutes and can be initiated only once per day. If user 30 is user 26's manager, communication process 10 may override 312 user 26's (the employee's) time-limitation settings with user 30's (the manager's) time-limitation settings. The example above uses a manager/employee relationship to determine how to override 312 the time-limitation settings. However, this is not meant to be a limitation. One skilled in the art will recognize that the time-limitation settings may be overridden 312 based on various criteria. For example, communication process 10 may override 312 a user's time-limitation settings based on which user initiated the communication session. Communication process 10 may also override 312 time-limitation settings based on a business policy. For example, a business policy's time-limitation settings may override 312 an individual user's time-limitation settings, etc. Communication process 10 may also override 312 time-limitation settings based on a class of users (e.g. a particular class of users' time-limitation settings may override another user's or group's time-limitation settings, etc).

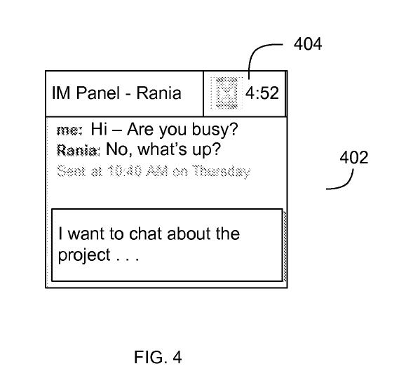

Communication process 10 may display 314 the first and/or second time-limitation settings on a computer display. FIG. 4 shows a graphical user interface displaying 314 a time-limitation setting. Panel 402 may be a graphical user interface for a communication client (e.g. an instant messenger application), such as communication client 24a, 24b, 24c. Graphical element 404 may display a time-limitation setting. Graphical element 404 may display the time remaining until a time-limitation setting expires and the communication session is terminated 308. As shown, graphical element 404 may be displaying a time of four minutes and fifty two seconds. Accordingly, in this example, the users engaged in the communication session may have four minutes and fifty-two seconds before communication process 10 terminates 308 the communication session. Additionally/alternatively, graphical element 404 may display the time remaining until a user may initiate 302 a subsequent communication session or resume a communication session. Graphical element 404 may be any graphical element capable of displaying a time-limitation setting including, but not limited to: a text box, a picture, an animation, a clock, etc.

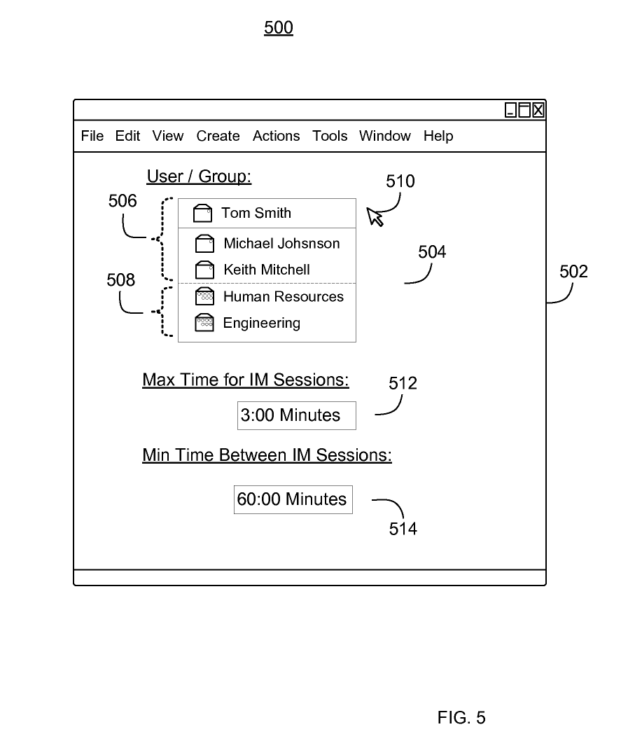

A user may enter time-limitation settings into an options dialog, an options window, a file, a database, or any other manner of entering time-limitation settings. For example, FIG. 5 shows an example of graphical user interface (“GUI”) 500 with which a user may set time-limitation settings. Window 502 may include drop down box 504, which may list various user identifications for users 506 and groups 508. A user may select one of the user identifications from drop down box 504 using, e.g. on screen pointer 510. In this example, the user may wish to set time limitations for communication sessions with Tom Smith, and may have selected user identifier “Tom Smith” from drop down box 504. One skilled in the art will recognize that the user may also select one or more other user identifiers, including user identifiers for individuals and/or for groups in a graphical user interface.

Windows 502 may also include setting 512, which may set a time limit for a maximum time for communication sessions. Setting 512 may, in this example, correspond to the first time-limitation setting which may limit the duration of communication sessions between a user and Tom Smith. Windows 502 may also include setting 514, which may set a time limit for a minimum time between communication settings. Setting 514 may, in this example, correspond to the second time-limitation setting which may set a minimum time between a communication session and a subsequent communication session with Tom Smith.

A user may enter time-limitation settings into window 502 prior to initiation of a communication session. Additionally/alternatively, if two users are already engaged in a communication session and then invite a third person to join the communication session, the two users may choose to set time-limitation settings for the third person. In this way, the two users may control the time the third person may join in the communication session. The two users may use window 502, for example, to set time-limitation settings for the third user upon inviting the third user, upon the third user joining the communication session, etc.

The example above describes a GUI and/or window which may be used to enter time-limitation settings. One skilled in the art will recognize that the GUI and/or window described is not intended to be a limitation and that a user may enter time-limitation settings in any manner including, but not limited to, entering time-limitation settings in: a GUI, a file, a database, or any other manner of entering settings known in the art. Additionally, window 502 as shown may or may not contain all possible options for entering time-limitation settings. Other options and settings for window 502 may be included or omitted depending upon system and/or user requirements.

A number of implementations have been described. Nevertheless, it will be understood that various modifications may be made. Accordingly, other implementations and other uses are within the scope of the following claims.

What is claimed is:

1. A method comprising:
initiating an instant messaging session on one or more communication devices;
receiving a first time-limitation setting for the instant messaging session based upon a user identification, the first time-limitation setting representing a maximum duration for the instant messaging session;
receiving a second time-limitation setting for the instant messaging session based upon the user identification, the second time-limitation setting representing a minimum time between one or more instant messaging sessions;
terminating the instant messaging session if the duration of the instant messaging session exceeds the first time-limitation setting; and
preventing initiation of a subsequent instant messaging session if the time between the instant messaging session and the subsequent instant messaging session does not exceed the second time-limitation setting.

2. The method of claim 1 wherein one or more of the instant messaging session and the subsequent instant messaging session include one or more of:
a video chat session; and
an audio chat session.

3. The method of claim 1 wherein one or more of the first time-limitation setting and the second time-limitation setting are based upon a user identification for a class of users.

4. The method of claim 1 wherein one or more of the first time-limitation setting and the second time-limitation setting are based upon an organizational position of a user associated with the user identification.

5. The method of claim 1 wherein one or more of the first time-limitation setting and the second time-limitation setting is based upon a weighting of the user identification, the weighting corresponding to a type of user associated with the user identification.

6. The method of claim 1 wherein one or more of the first time-limitation setting and the second time-limitation setting is based upon a distance between two or more instant messaging session participants in a social networking graph.

7. The method of claim 1 wherein one or more of the first time-limitation setting and the second time-limitation setting is based upon a policy of a business organization.

8. The method of claim 1 further comprising displaying one or more of the first time-limitation setting and the second time-limitation setting on a computer display.

9. The method of claim 1 further comprising overriding one or more of the first time-limitation setting and the second time-limitation setting based upon the user identification and one or more time-limitation settings set by the user associated with the user identification.

10. A computer program product, residing on a computer readable storage device, having a plurality of instructions stored thereon, which, when execute by a processor, cause the processor to perform operations comprising:
initiating an instant messaging session on one or more communication devices;
receiving a first time-limitation setting for the instant messaging session based upon a user identification, the first time-limitation setting representing a maximum duration for the instant messaging session;
receiving a second time-limitation setting for the instant messaging session based upon the user identification, the second time-limitation setting representing a minimum time between one or more instant messaging sessions;
terminating the instant messaging session if the duration of the instant messaging session exceeds the first time-limitation setting; and
preventing initiation of a subsequent instant messaging session if the time between the instant messaging session and the subsequent instant messaging session does not exceed the second time-limitation setting.

11. The computer program product of claim 10 wherein one or more of the instant messaging session and the subsequent instant messaging session include one or more of:
a video chat session; and
an audio chat session.

12. The computer program product of claim 10 wherein one or more of the first time-limitation setting and the second time-limitation setting are based upon a user identification for a class of users.

13. The computer program product of claim 10 wherein one or more of the first time-limitation setting and the second time-limitation setting are based upon an organizational position of a user associated with the user identification.

14. The computer program product of claim 10 wherein one or more of the first time-limitation setting and the second time-limitation setting is based upon a weighting of the user identification, the weighting corresponding to a type of a user associated with the user identification.

15. The computer program product of claim 10 wherein one or more of the first time-limitation setting and the second time-limitation setting is based upon a distance between two or more instant messaging session participants in a social networking graph.

16. The computer program product of claim 10 wherein one or more of the first time-limitation setting and the second time-limitation setting is based upon a policy of a business organization.

17. The computer program product of claim 10 wherein the operations further comprise displaying one or more of the first time-limitation setting and the second time-limitation setting on a computer display.

18. The computer program product of claim 10 wherein the operations further comprise overriding one or more of the first time-limitation setting and the second time-limitation setting based upon the user identification and one or more time-limitation settings set by the user associated with the user identification.
